(19) United States
(12) Patent Application Publication
(10) Pub. No.: US 2006/0098659 A1
(43) Pub. Date: May 11, 2006

(54) Method of data packet transmission in an IP link striping protocol

(75) Inventor: David Gordon Chinner, Hawthorn East (AU)

Correspondence Address: Silicon Graphics Inc., MS 710, 1500 Crittenden Lane, Mountain View, CA, 94043, US

(73) Assignee: Silicon Graphics Inc.

(21) Appl. No.: 10/982,149

(22) Filed: Nov. 5, 2004

(51) Int. Cl. H04L 12/56

(52) U.S. Cl. 370/394

(57) ABSTRACT

A method of preparing a data packet for transmission in an IP link striping protocol comprises selecting a packet sequence number. An encapsulation header comprising the packet sequence number is appended to the data packet to create a protocol data unit (PDU). Based on the packet sequence number, one of a plurality of physical links for transmission of the packet is selected.

### FIELD OF THE INVENTION

This invention relates to data network communications and, in particular, to increasing data throughput in a data network.

### BACKGROUND OF THE INVENTION

A data network enables transfer of data between nodes or entities connected to the network. The TCP/IP suite has become the most widely used interoperable data network architecture. TCP/IP can be classified as having five layers: an application layer providing user-space applications with access to the communications environment; a transport layer providing for reliable data exchange; an internet layer to provide routing of data across multiple networks; a network access layer concerned with the exchange of data between an end system and the network to which it is connected; and a physical layer addressing the physical interface between a node and a transmission medium or network.

Local area networks (LANs) are commonly implemented using Fast Ethernet or Gigabit Ethernet systems residing at the network layer, set out in the IEEE 802.3 standard. Over a single connection in such networks, transfer of large amounts of data such as video data can take hours, delaying any further use of the data being transferred.

The most common protocol at the transport layer is the Transmission Control Protocol (TCP), providing data accountability and information ordering. TCP uses ordering numbers to indicate the order in which received packets should be assembled. TCP re-orders packets and requests re-transmission of lost packets. TCP enables computers to simulate, over an indirect and non-contiguous connection, a direct machine-to-machine connection.

A simpler protocol applicable at the transport layer is the User Datagram Protocol (UDP) which has optional checksumming for data-integrity. UDP does not address the numerical order of received packets and is thus considered to be best suited to small information transmissions which can be handled within the bounds of a single IP packet. UDP is used primarily for broadcasting messages over a network.

Protocols at the transport layer and internet layer append headers to a data segment to form a protocol data unit (PDU).

### SUMMARY OF THE INVENTION

A method of preparing a data packet for transmission in an IP link striping protocol comprises selecting a packet sequence number. An encapsulation header comprising the packet sequence number is attached to the data packet to create a protocol data unit (PDU). Based on the packet sequence number, one of a plurality of physical links for transmission of the packet is selected.

### BRIEF DESCRIPTION OF THE DRAWINGS

FIG. 1 illustrates a communications link between two nodes, comprising multiple physical links over a network;

FIG. 2 illustrates operation of a TCP/IP network stack in accordance with a tunnelling protocol of a first embodiment of the invention;

FIG. 3A illustrates formation of a data packet structure at each layer of the network stack of FIG. 2 prior to packet transmission;

FIG. 3B illustrates the process steps involved in the formation of the data packet structure;

FIG. 3C illustrates retrieval of a data payload after reception of the data packet;

FIG. 3D illustrates the process steps involved in retrieval of the data payload;

FIG. 4 illustrates the distribution of packets to physical links based on packet sequence number; and

FIG. 5 illustrates operation of a piece-wise hash table for re-ordering data packets received over a plurality of links.

### DETAILED DESCRIPTION OF EXEMPLARY EMBODIMENTS

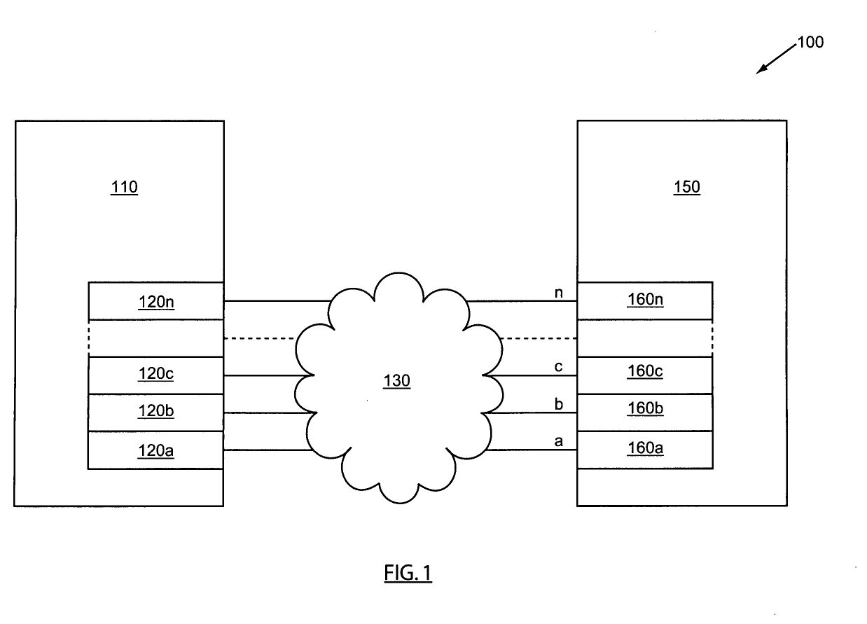

FIG. 1 illustrates a network arrangement 100 in which a network striping protocol, in accordance with an embodiment of the invention, is used. A first network node 110 comprises a plurality of network interface cards 120a, 120b, 120c, . . . 120n, each providing a physical interface to a network 130. A second network node 150 comprises a plurality of network interface cards 160a, 160b, 160c . . . 160n, each providing a physical interface to the network 130. Physical links a, b, c . . . n are established between each physical interface 120 and a respective physical interface 160. A stripe driver (not shown but explained in detail below) of the node 110 distributes a data stream from a user application of node 110 across the plurality-of physical links a, b, c, . . . n to provide the user application with substantially the sum of the bandwidth of all of the physical links a, b, c . . . n.

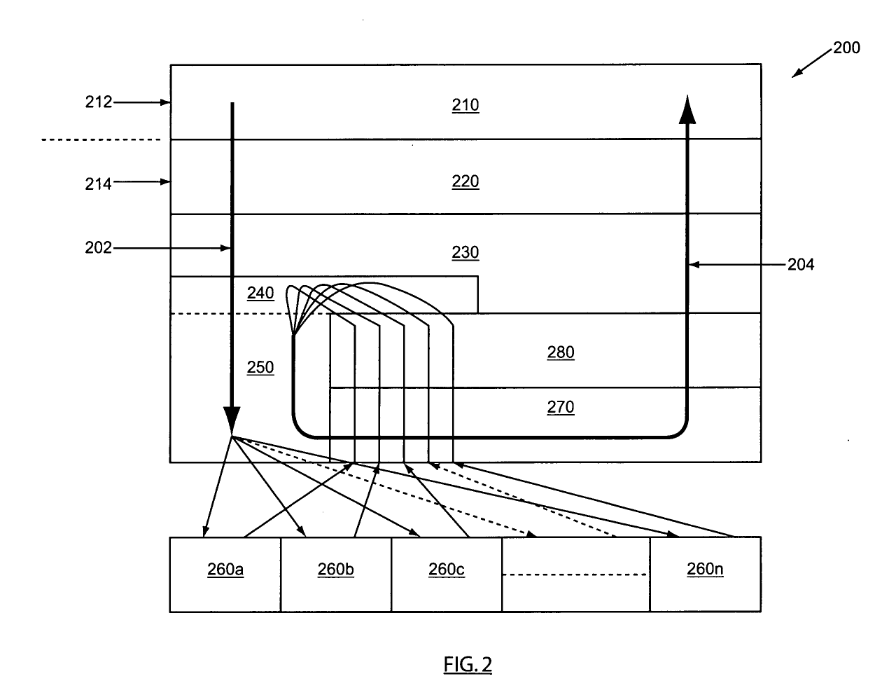

FIG. 2 illustrates a network stack 200 embodying the exemplary embodiment. User application(s) 210 reside in a user space 212 of the stack 200 and interface with a socket interface layer 220 of a kernel space 214 when requiring network data transfer. An output path 202 takes data from the user application(s) 210 via the socket interface layer 220 through the network stack 200 via layer 4 protocols 230 (for example TCP or UDP), applies user datagram protocol (UDP) encapsulation in layer 240 and uses a stripe driver in layer 250 to stripe the data across multiple physical interfaces comprising network interface card (NIC) drivers 260a, 260b, 260c . . . 260n, all in one pass.

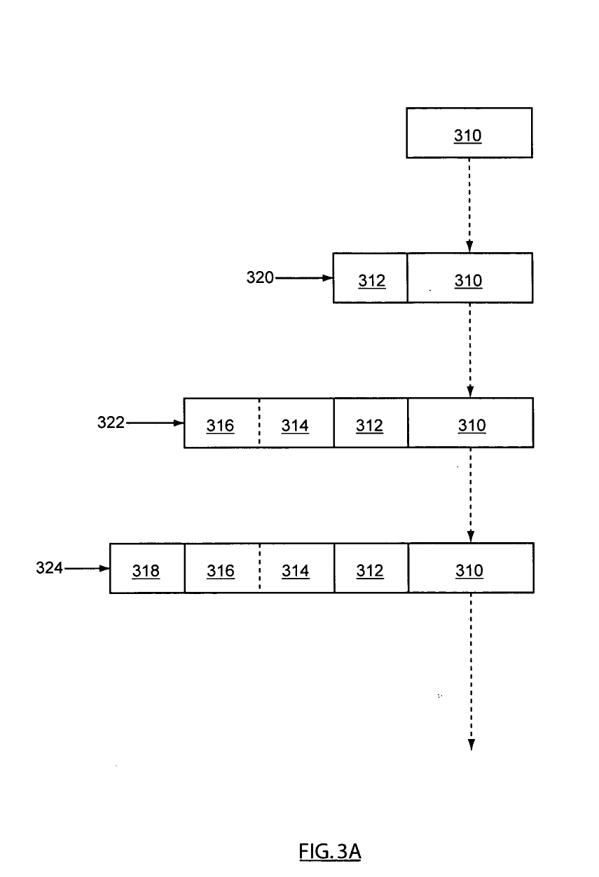

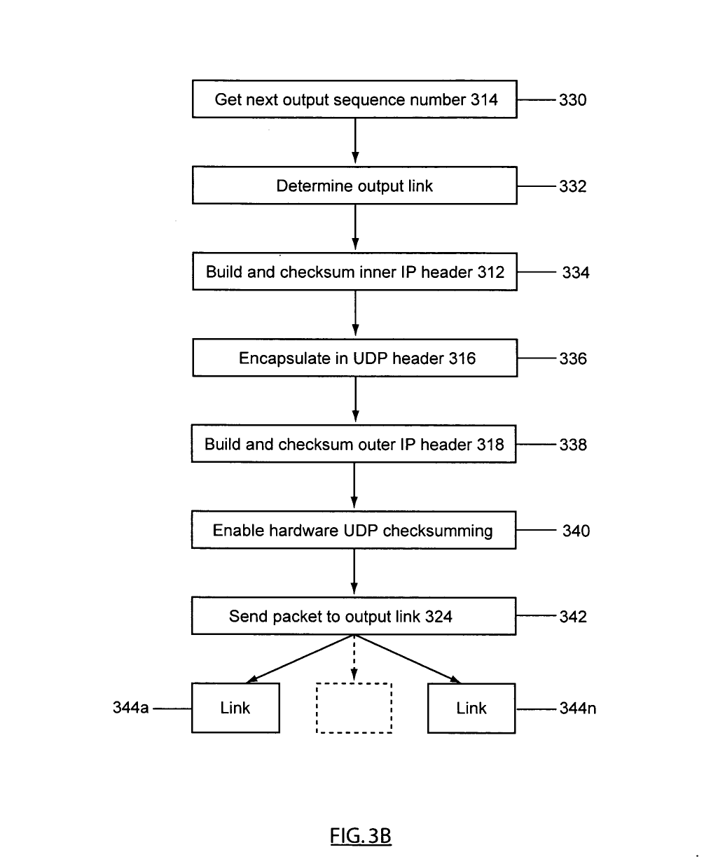

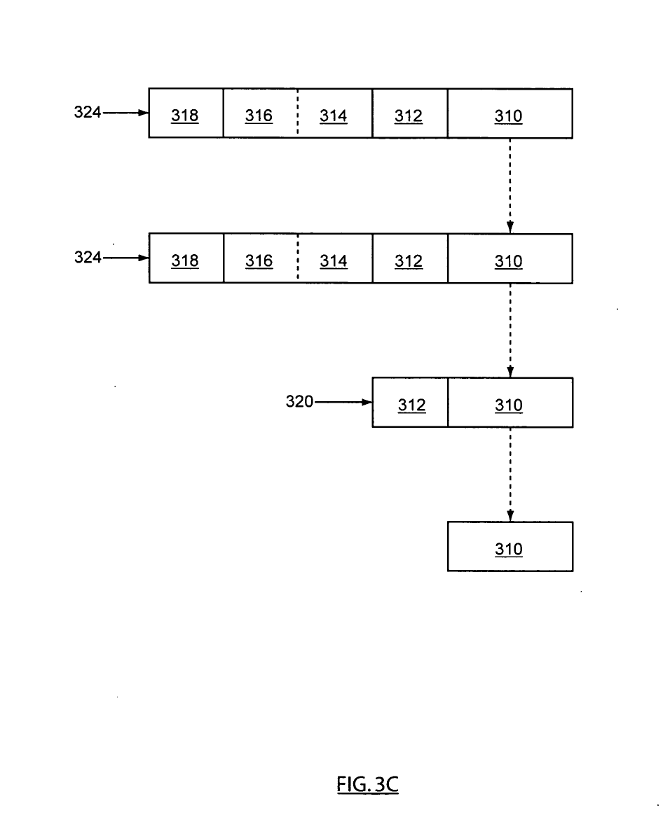

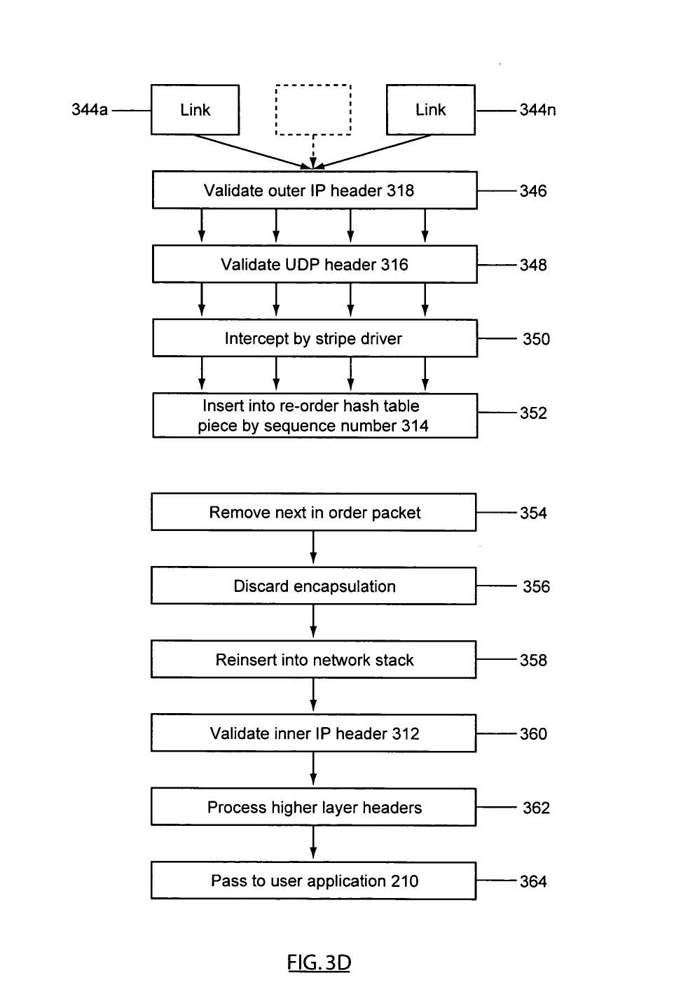

The encapsulation and striping portions of the output path 202 are described in greater detail below with reference to FIG. 3 of the drawings. FIG. 3 illustrates an embodiment of preparing a data packet for transmission in an IP link striping protocol in which a packet sequence number is selected, a UDP header comprising the packet sequence number is attached to the data packet to create a UDP protocol data unit (PDU) and, based on the packet sequence number, one of a plurality of output links for transmission of the packet is selected. Thus, the transmitted data packet for the IP link striping protocol has a data payload and a UDP header having a packet sequence number.

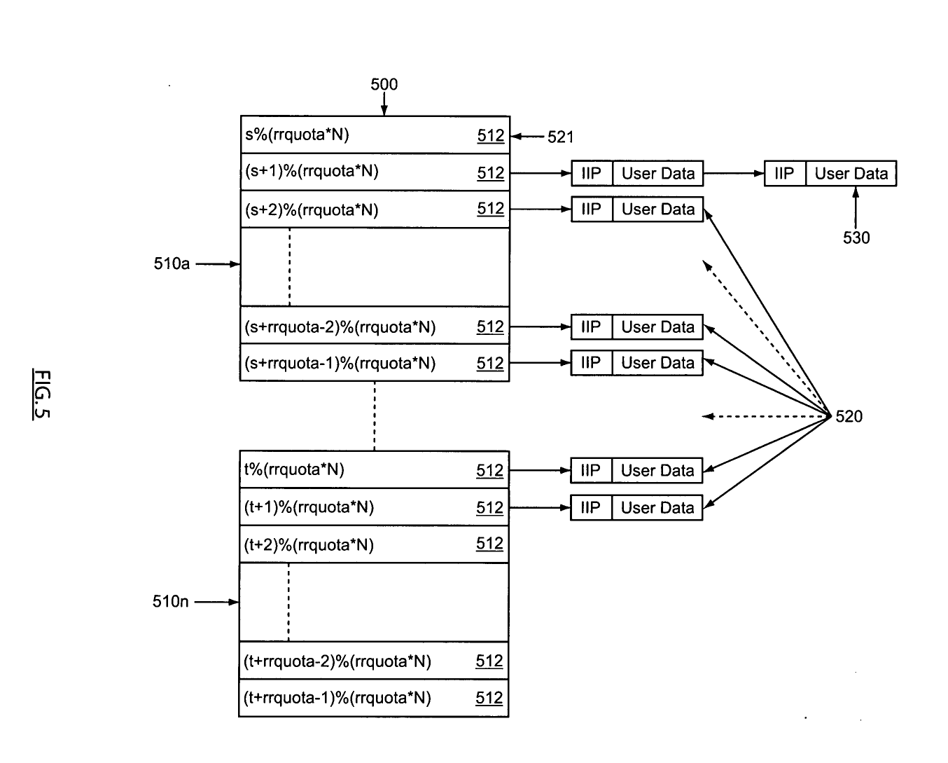

An input path 204 of the exemplary network stack 200 is more convoluted, involving the physical interfaces 260 pushing data packets in parallel through a network input layer 270 and an IP layer 280 into the UDP layer 240 where the parallel packets are intercepted by the stripe driver 250. The stripe driver 250 strips the encapsulation from the intercepted packets and places the packets in order. The method of re-ordering received data in the IP link striping protocol includes inserting each received data packet into one of a plurality of hash pieces of a piece-wise hash table, as will be described in greater detail below with reference to FIG. 5 of the drawings. Each hash piece of the piece-wise hash table holds data packets from a unique link of a plurality of input links. Data packets are then retrieved from each hash piece in order of a packet sequence number in the UDP header of each received packet. Once reordering is complete, the reordered packets are once again passed through the network input layer 270 and delivered to the user application(s) 210 via the input stack processing methods of layers 280, 230 and 220, respectively.

The socket interface layer 220 isolates the user space 212 from the operations in the kernel space 214 by providing a communications link and thus the layers of the kernel space 214 below the socket interface layer 220 are transparent to user applications 210. Accordingly, the exemplary embodiment, operating wholly below the socket interface layer 220, transparently provides IP link striping for increased bandwidth to the user application(s) 210.

FIGS. 3A and 3B illustrate the encapsulation and striping of data as part of the output path 202, with FIG. 3A showing the data packet structure and FIG. 3B showing the process steps performed. In FIG. 3A, a data payload 310 is ready for processing in accordance with the exemplary embodiment. In FIG. 3B, at step 330, a next sequence number 314 is obtained. At step 332, the process determines an output link corresponding to that sequence number 314. At step 334, the process builds and checksums an inner IP header 312, thus creating an inner IP protocol data unit (PDU) 320. At step 336, the process encapsulates the inner IP PDU 320 by applying a UDP header 316 and the sequence number 314, to create a UDP PDU 322. At step 338, the process builds and checksums an outer IP header 318 and attaches the outer IP header 318 to the UDP PDU 322 to create an outer IP PDU data packet 324. It will be appreciated that two IP headers are required due to the use of UDP encapsulation of the inner IP header 312. This enables hardware checksumming to be used and the sequence number 314 to be held. However, due to the fact that the networks understand IP datagrams but not UDP headers, or datagrams, an outer IP header 318 is attached to the UDP header 316 to enable the data packet 324 to be transmitted by the network. At step 340, the process enables UDP checksumming, thus enabling checksumming to be performed in hardware and avoiding loading a CPU with software checksum processing. At step 342, the process selects a physical link 344 with which the sequence number 314 is associated from a plurality of physical links 344a . . . 344n and directs the packet 324 to that link 344.

FIGS. 3C and 3D illustrate the processing of parallel, received data packets 324 as part of the input path 204 of the network stack 200, with FIG. 3C showing the stripping of the data packets 324 and FIG. 3D showing the process steps performed. In FIG. 3C, the data packets 324 are received on at least some of the links 344a . . . 344n ready for processing. At step 346, in FIG. 3D, the outer IP header 318 of each data packet 324 is validated. At step 348, the UDP header 316 of each data packet 324 is validated. The data packets 324 are then intercepted by the stripe driver 250 at step 350 and each data packet 324 is inserted into one of a plurality of hash pieces of a piece-wise hash table at step 352.

At step 354, the next in order data packet 324 is removed from the piece-wise hash table and, at step 356, the encapsulation of the data packet 324 is discarded to provide the PDU 320 which is reinserted into network stack 200 via the network input layer 270 at step 358. The inner IP header 312 is validated and stripped in the IP layer 280 at step 360 and higher layer headers are processed in layers 230 and 220 at step 362 to enable the data payload 310 to be passed to the user application(s) at step 364.

Thus, to enable the two IP headers to be processed, two passes of the data packet 324 through the network input layer 320 are required. In the first pass through the network input layer 270, the outer IP header 318 is validated and passes the data packet 324 to the UDP layer 240 where the data packet 324 is intercepted by the stripe driver 250 and placed into the reorder hash table. When the in order data packet 324 is removed from the hash table, the outer IP header 318, the UDP header 316 and the sequence number 314 are removed leaving the PDU 320. To validate and process the PDU 320, it needs to be re-inserted into the network stack 200 at the base of the network stack, i.e. at the network input layer 270.

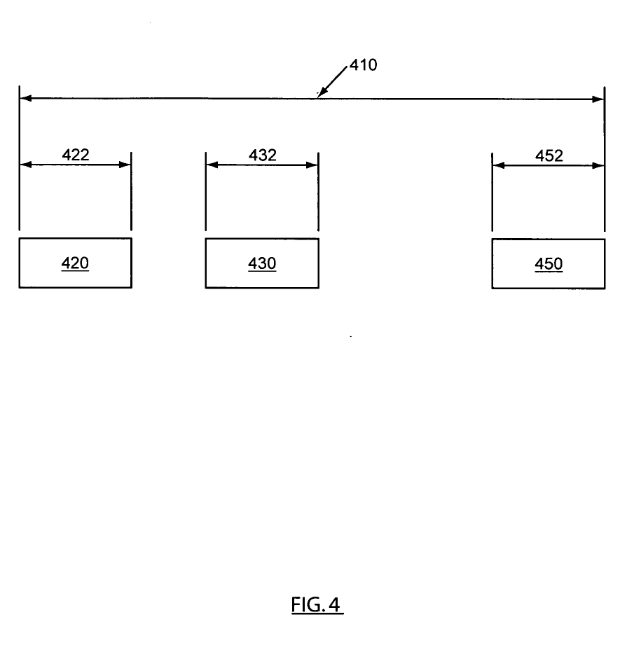

FIG. 4 illustrates the distribution of packets to physical links based on packet sequence number, in accordance with the exemplary embodiment. A round robin quota (rrquota) is the number of consecutive packets allocated to a single link, with the next rrquota of sequence numbers being allocated to a subsequent link and so on. Thus, a range 410 of sequence numbers is required to cover N links=(rrquota*N). Further, where S is the next output sequence number, the sequence number ranges allocated for each link are as follows:

First Link 420: Sequence number range 422=(S % rrquota)

Second Link 430: Sequence number range 432=((S % rrquota)+(rrquota))

For example, Table A below illustrates such sequence number allocation where rrquota=64 packets and N=4.

TABLE A
Link allocations of packet sequence numbers

| Link 1 | Link 2 | Link 3 | Link 4 |
|---|---|---|---|
| 0-63 | 64-127 | 128-191 | 192-255 |
| 256-319 | 320-383 | 384-447 | 448-511 |
| 512-575 | 576-639 | 640-703 | 704-767 |
| . . . | . . . | . . . | . . . |

The exemplary embodiment recognises that scalability with an increasing number of physical links of a reorder algorithm applied at the receive side (such as is set out in FIG. 5) can be facilitated by crafting the allocation of packets to particular known physical links, for example, by using an algorithm such as that shown in FIG. 4 and Table A for applying the sequence numbers to data packets at the transmit side. Effectively, by transmitting a known pattern of sequence numbers across each physical link, the receive side “knows” where the packet came from and, hence, storage structures can be created at the receive side that maintain extremely good locality. Such storage structures can minimise cacheline and lock contention due to the control of placement of data which is made possible.

The mechanism set out in FIG. 4 and Table A results in a distinctive characteristic of a stripe interface as the stripe inherently treats each physical link as an identical pipe. Consequently, the maximum transmission unit (MTU) of the stripe must be set to be the smallest MTU of all of the physical links. Additionally, when streaming data via TCP over the stripe, the slowest link is that which determines the round trip time for flow control by TCP and, hence, TCP only transmits enough data to maximise the throughput of the slowest link. Hence the bandwidth BW available to the stripe interface across N physical interfaces is:
BW=(MIN(MTU of all links)*MIN(maximum link throughput of all links))*N

Thus, in further embodiments of the invention, a more sophisticated sequence number link allocation algorithm such as SRR (Surplus Round Robin) or DRR (Deficit Round Robin) may be adopted in order to exploit the capabilities of each link more efficiently. In such embodiments, the sequence number to physical link correlation would still be used to enable a scalable reorder algorithm similar to that set out in FIG. 5 to be used.

FIG. 5 illustrates operation of a piece-wise hash table 500 for re-ordering data packets received over a plurality of links. The hash table 500 operates on data packets intercepted by the stripe driver 250. The hash table 500 has N “hash pieces”, with the hash pieces 510a . . . 510n having a one-to-one correspondence with the N physical links of the stripe. Each hash piece 510 contains exactly rrquota entries or sequence number entry slots 512.

Due to the sequence number to physical link correlation imposed at transmission, the data packets received across a particular physical link will all have sequence numbers which place that data into the hash piece 510 corresponding to that physical link. Accordingly, the entire hash table 500 has exactly rrquota*N sequence number entry slots 512. The sequence number entry slots 512 of hash piece 510a correspond, respectively, to sequence numbers s % (rrquota*N), (s+1) % (rrquota*N), . . . , (s+rrquota−1) % (rrquota*N). Similarly, the sequence number entry slots 512 of hash piece 510n correspond, respectively, to sequence numbers t % (rrquota*N), (t+1) % (rrquota*N), . . . , (t+rrquota−1) % (rrquota*N), where t=s+(rrquota*(N-1)).

In the exemplary embodiment, each hash piece 510 has its own lock so that multiple interfaces can be simultaneously inserting data into their corresponding hash piece without contention. Once again, such embodiments facilitate scaling of the striping protocol with an increasing number N of physical links.

FIG. 5 illustrates at 520 the packets which have been received, which are also in order due to the piece-wise hash table 500 in use. These ordered packets 520 are held until arrival of a next expected sequence number, indicated at 521 after which the packets 520 can be processed in order. FIG. 5 further illustrates an ‘overflow’ packet 530, which has a sequence number of (s+1+(rrquota*N)) % (rrquota*N). Another feature of the exemplary embodiment is that such overflow packets do not require double handling as packet 530 naturally falls into place as the linked list window moves forward for that slot when the packets 520 are finally processed.

The exemplary embodiment recognises that the reordering problem can be considered as an attempt to order a set of pointers that represent a linearly increasing sequence of data over time. The sequence number can be determined from the data pointer and the data structures (mbufs) can be linked. In considering a simple hash table, the first entry into a hash table is head of a linked list. The entries on that list are there because they have the same hash key. The exemplary embodiment recognises that the sequence number can be considered as a hash awaiting division into hash pieces. Further, by ordering the lists of each slot of each hash piece, it is possible to hold in order any overflow packets on the same list. Still further, as the lists are hashed, the list length is significantly reduced compared to a linked list, maintaining low overhead in list management functions.

To monitor the state of transmission, it is sufficient to record three key sequence numbers: the earliest underflow, the next expected sequence number and the sequence number of the last packet received. The earliest underflow indicates a maximum distance back which must be checked for underflows when an underflow has occurred (as everything sent up the stack is done so by the reorder thread). In the exemplary embodiment, underflow packets are stored in a list separate from the hash table of FIG. 5, thus providing a further optimisation which greatly simplifies the insertion of packets into, and removal of packets from, the reorder hash lists of the hash table 500.

Notably, it is not required to maintain an end of window record due to the use of an ordered list on the hash keys. If a matching sequence number has not been received, the entry will be null and hence easily detectable. If an overflow has occurred on that hash key, the list will have multiple elements in it, as illustrated at 530. Empty, overflowed keys can also be detected as the sequence number will be one hash table length too large.

To facilitate both single threaded and multi-threaded retrieval implementations, asynchronous or synchronous retrieval of ordered data packets from the hash table 500 can be effected.

A further advantage offered by the exemplary embodiment is that the majority of operations will be on list heads, such that for a majority of the time the insert and remove operations will be O(1) if the window size is at least:
size=send round robin quota*number of physical links*2

The reorder structure of the present embodiment is referred to herein as a piece-wise hash list, as every physical link supplies its own piece of the hash list for storing packets that are received on that link. Hence, as the number of physical links increases, the width of the hash table also increases which preserves the O(1) insert and remove characteristic.

This exemplary embodiment thus includes an algorithm that is capable of reconstructing the correct order of packets in a manner that may provide greater than 97% of the physical bandwidth provided by multiple interfaces to the conglomerated logical interface that the application uses. Such scaling may be effected in conjunction with as many CPUs as needed to process all the reordered packets. In one application of the present invention, striping multiple gigabit Ethernet cards to appear as a single interface may provide a cost effective manner in which to provide increased bandwidth to a single logical connection, particularly to provide an effective interim solution before introduction of (potentially expensive) 10 gigabit Ethernet systems. The present invention may further find application in other network systems by enabling applications to make better use of available network bandwidth.

Further, it is notable that in the exemplary embodiment, the striping algorithm is self-synchronizing and hence does not need marker or synchronization packets to maintain send/receive synchronization. Additionally, the present invention provides combined bandwidth to a single application through a single socket without requiring the application to establish a unique socket connection to the network stack for each physical link. Accordingly, no changes in application configuration are necessary to take advantage of stripe bandwidth in the exemplary embodiment. That is, the stripe of the exemplary embodiment is completely transparent to applications. Further, the present invention may exploit any physical or logical interface that can be configured as a physical link. In preferred embodiments, it is possible to dynamically add and remove physical links to the stripe set, with the available striped bandwidth changing accordingly.

By using standard IP protocol headers and tunnelling the present UDP based protocol, communication in accordance with the exemplary embodiment are completely routable and may be run on any existing IP based network without any infrastructure changes. Further, given the nature of the IP checksum, verifying that the outer packet UDP checksum is correct verifies that the payload is intact and hence it is unnecessary to re-checksum the inner IP packet and payload. The exemplary embodiment this provides a tunnel that the logical stripe interface uses, that performs hardware checksum and conveys sequence numbers, thereby saving a large amount of CPU overhead, enabling simple reordering of received packets and hence allowing easy increases in stripe throughput.

The phrase “piece-wise hash list” is used herein to refer to a reorder structure comprising a plurality of hash keys in which each physical link is the unique source of entries under a single hash key. In the exemplary embodiment each hash key may be associated with a linked list built from data packets received over one physical link, whereby the number of hash keys is equal to the number of physical links.

The exemplary embodiment recognizes that, to transparently improve the network bandwidth available to an application, multiple physical network interfaces can be conglomerated into a single logical interface that provides to the application the combined bandwidth of all the conglomerated physical interfaces. However, due to the nature of the protocols used in current networks, the ordering of the packets sent across the network must be maintained to ensure that substantially the full conglomerated bandwidth can be used by the application. The exemplary embodiment further recognizes that a main problem with network striping is in keeping packets in order at the receiver. Given that there is no inherent synchronization between multiple network interfaces, the exemplary embodiment recognizes that efficient reordering of packets delivered out-of-order is important in providing a network stripe protocol which is scalable to N network interfaces.

The striping protocol of the exemplary embodiment enables cost-effective supply of significantly greater bandwidth to a network user, thereby significantly reducing the time it takes to move data across the networks, and allowing more time to be spent working on that data.

The phrase “logical interface” is used herein to refer to a network interface that has no physical connection to an external network but still provides a connection across a network made up of physical interfaces. The term “tunnelling” is used herein to refer to a method of encapsulating data of an arbitrary type inside a valid protocol header to provide a method of transport for that data across a network of a different type. A tunnel requires two endpoints that understand both the encapsulating protocol and the encapsulated data payload. The phrase “network stripe interface” is used herein to refer to a logical network interface that uses multiple physical interfaces to send data between hosts. The data that is sent is distributed or “striped”, evenly or otherwise, across all physical interfaces hence allowing the logical interface to use the combined bandwidth of all the physical interfaces associated with it.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of preparing a data packet for transmission in an IP link striping protocol, comprising:
selecting a packet sequence number;
attaching an encapsulation header comprising the packet sequence number to the data packet to create a protocol data unit (PDU); and
based on the packet sequence number, selecting one of a plurality of physical links for transmission of the packet.

2. The method of claim 1, wherein selecting a packet sequence number follows a packet ordering algorithm adaptable in response to link congestion.

3. The method of claim 1 wherein selecting a packet sequence number follows a packet ordering algorithm which allocates packets evenly to each physical link.

4. The method of claim 1, further comprising enabling hardware checksumming.

5. The method of claim 1, further comprising appending an inner IP header to a data payload to create an inner IP PDU to which the encapsulation header is to be attached.

6. The method of claim 5, further comprising attaching an outer IP header to the encapsulation PDU to create an outer IP PDU.

7. A method of re-ordering received data in an IP link striping protocol, comprising:
inserting each received data packet into one of a plurality of hash pieces of a piece-wise hash table, wherein each hash piece of the piece-wise hash table comprises data packets from a unique link of a plurality of input links; and
retrieving data packets from each hash piece in order of a packet sequence number in an encapsulation header of each received packet.

8. The method of claim 7 wherein each hash piece comprises a plurality of sequence number entry slots and wherein inserting each received data packet comprises inserting each data packet received over the physical link associated with the hash piece into a linked list of one of the plurality of sequence number entry slots, based on the sequence number of that data packet.

9. The method of claim 7 further comprising providing a plurality of locks for the hash table to avoid contention during said inserting.

10. The method of claim 7 further comprising using asynchronous retrieval of ordered data packets from the piece-wise hash table.

11. The method of claim 7 further comprising using synchronous retrieval of ordered data packets from the piece-wise hash table.

12. A data packet for an IP link striping protocol, the data packet comprising:
a data payload; and
an encapsulation header having a packet sequence number.

13. An IP link striping protocol comprising UDP encapsulation of packet sequence numbers.

14. A method of implementing an IP link striping protocol comprising encapsulating packet sequence numbers using UDP at a transport layer.
